(19) United States
(12) Patent Application Publication
(10) Pub. No.: US 2013/0166913 A1
(43) Pub. Date: Jun. 27, 2013

(54) Encryption Device and Method

(71) Applicant: James Evan Lenon, Unley (AU)

(72) Inventor: James Evan Lenon, Unley (AU)

(73) Assignee: Emue Holdings Pty Ltd., Melbourne (AU)

(21) Appl. No.: 13/811,896

(22) PCT Filed: Jul. 18, 2011
(86) PCT No.: PCT/AU2011/000904

§ 371 Date: Mar. 12, 2013

(30) Foreign Application Priority Data
Jul. 23, 2010 (AU) 2010903315

(51) Int. Cl. H04L 9/32

(52) U.S. Cl. CPC H04L 9/3244
USPC 713/170

(57) ABSTRACT

A method is disclosed of encrypting a value input into a user device storing an authentication key, a code generation algorithm, and a value verification code generation algorithm. The method includes the user device processing the authentication key using the code generation algorithm to generate an authentication code; and the user device processing the value using the value verification code generation algorithm to generate a value verification code. The method further includes the user device using the authentication code, the value and the value verification code to construct a message encrypting the value, the message for communicating to an authentication system via a communications network for processing by the authentication system to determine and verify the value, and authenticate the user device and/or the user. A method of communicating a value input into a user device to an authentication system and of verifying the value so communicated as well as an associated user device and authentication system are also disclosed.

### FIELD OF THE INVENTION

The present invention relates generally to methods and devices for encrypting a value, such as a personal identification number (PIN), for communication over an untrusted or unsecure communication network.

### BACKGROUND TO THE INVENTION

In many electronic authentication systems a user is required to provide proof of authorisation before accessing a service, such as internet banking, on-line shopping, an automatic teller machine, share trading, bill payment, electronic funds, a telecommunications service, or access to a room or vehicle. The proof of authorisation may be in the form of a password or PIN that the user must enter or otherwise provide before they are allowed access.

Users are advised to keep their PIN secret and to change it regularly, to reduce the likelihood of it being discovered by a malicious third party. Increasing the duration between PIN changes, may increase the likelihood of it being detected and thus used to obtain unauthorised access to the service, room or vehicle.

One method of changing a PIN over a communications network involves establishing a secure tunnel, for example, using the Secure Shell (SSH) protocol, wherein unencrypted data may be transferred over the network through an encrypted tunnel to a server. However, this method may be quite processor intensive, and involves communication resources and overheads in establishing the tunnel. Furthermore, although the secure tunnel may prevent a “man in the middle” from obtaining the PIN, the PIN may nevertheless be susceptible to tampering and/or interference by a “man in the middle” type attack which is not detectable by the server.

It would be desirable to communicate a value, such as a PIN, in a manner which requires reduced processing requirements and which is less susceptible to a “man in the middle” type attack.

The above discussion of background art is included to explain the context of the present invention. It is not to be taken as an admission that any of the documents or other material referred to was published, known or part of the common general knowledge at the priority date of any one of the claims of this specification.

### SUMMARY OF THE INVENTION

According to one aspect, the present invention provides a method of encrypting a value input into a user device storing an authentication key, a code generation algorithm, and a value verification code generation algorithm, the method including:

the user device processing the authentication key using the code generation algorithm to generate an authentication code;

the user device processing the value using the value verification code generation algorithm to generate a value verification code; and

the user device using the authentication code, the value and the value verification code to construct a message encrypting the value, the message for communicating to an authentication system via a communications network for processing by the authentication system to determine and verify the value, and authenticate the user device and/or the user.

The method may allow communication of an encrypted value using reduced processor throughput or communication resource requirements as compared with establishing and communicating via a secure tunnel. Instead of communicating unencrypted data inside encrypted data packets, in an embodiment of the present invention the data may be encrypted, which in this case is the value. The reduced processor throughout is expected to reduce power consumption and thus render the method particularly suitable for use with a low-power user device. Also, unlike a secure tunnel, which communicates unencrypted traffic over a network using an encrypted channel, embodiments of the present invention may construct a message encrypting the value which may be communicated via an untrusted or unsecure communications channel.

Embodiment of the present invention may address the problem of “man in the middle” type attacks. For example, if an attacker intercepted the message, not only would the value be concealed from the attacker, but in addition, the attacker would be unable to substitute a verifiable value for transmission to the authentication system. Indeed, even if an attacker had knowledge of the particular bits or elements of the message associated with the encrypted value, because the value verification code is generated from the value encrypted by the message, if an attacker attempted to substitute a different encrypted value, such as by tampering with an intercepted message, and communicate this to the authentication system, the attacker would be unable to generate a valid value verification code for the substituted value.

Embodiments of the present invention may construct a message which communicates a value including, for example, a PIN known only to the user, such as would be the case, for example, where a user selects a new or replacement PIN. Furthermore, because the message is constructed by processing an authentication key which is unique to the user device, the message may also contain information which can be used in an authentication process for authenticating the user device and/or the user. In other words, a method embodiment of the present invention may construct a message from which the value and authentication information may be derived or determined by the authentication system.

The user device may include a smart card, mobile phone, hand held computer, notepad computer, tablet computer, desktop computer, personal digital assistant (PDA), or any other suitable device.

The value may include, for example a password, PIN, credit card number, other number, string, character, array, data structure, or any other data. Where the value is a PIN, the PIN may comprise a replacement or new PIN (‘the new PIN’) for communication to the authentication system to replace an existing PIN (‘the old PIN’). The user may select and input the new PIN into the user device. If an attacker intercepted the message, the new PIN would be concealed from the attacker. Furthermore, if the attacker attempted to transmit a substitute replacement PIN to the authentication system, the attacker would be unable to validly encrypt the substitute replacement PIN without access to the authentication key. Further, if the attacker transmitted a different message to the authentication system, the message would contain an invalid value verification code, and thus the new PIN would not be verified and updated at the authentication system. In this respect, even in the unlikely event that the attacker guessed a valid value verification code, the attacker would not be able to deduce the new PIN recorded at the authentication system without knowing the authentication key.

The authentication key is preferably a secret key, such as a symmetric key that is shared with the authentication system. The authentication key may include, for example, a seed, code or data sequence, such as a 256-bit binary code. The authentication key may be a fixed or static key, or it may include a one-time usable key which is updated on each iteration of the authentication code generation algorithm, or possibly after the expiry of a predetermined time period.

The user device may communicate the message to the authentication system via a suitable communications channel, or it may construct the message as an output for communication to the authentication system via another means, such as by the user entering the message into a different device, such as a communications terminal adapted to communicate the constructed message to the authentication system via a communications network.

In an embodiment in which the user device communicates the message to the authentication system, the user device may include a wired and/or wireless communications interface for communicating the constructed message either directly to the authentication system or indirectly via a network node in data communication with the authentication system via a suitable data communications network.

In an embodiment in which the user device outputs the message to the user for user input into a device, such as a communications terminal, for communication to the authentication system, the user device need not include a wired and/or wireless communications interface, but may instead include a user interface, such as a display, for outputting the message to the user. A suitable user interface may include, for example, a display (such as an LED or LCD display) or an audio output interface. In yet another embodiment the user device may include a wired and/or wireless communications interface for communicating the constructed message to an intermediate communications device, such as a second user device, for outputting the message to the user for the user to then enter into, or otherwise communicate, the constructed message to the authentication system. By way of example, a user device may include an electronic data communications interface for communicating the constructed message to the second user device, such as a mobile phone, in an electronic data communication such as a short message service message (SMS), an email message, instant messaging service or the like to a second user device, such as a mobile phone, a hand held computer, a notepad computer, a tablet computer, a desktop computer, a personal digital assistant (PDA), or the like.

In relation to the wired communications interface referred to above, suitable wired communications interfaces may include, for example, a USB interface, a IEEE802.3 interface, a serial peripheral interface bus (SPI) interface, a contact smart-card interface, or the like. Other suitable wired communications interfaces would be known to a skilled addressee. Suitable wireless communications interfaces may include, for example, a magnetic stripe interface, an optical interface, a IEEE802.11 wireless interface, a Bluetooth interface, a ZigBee® interface, wireless USB, a contactless smart-card interface, or the like. Other suitable wireless communications interfaces would be known to a skilled addressee.

Processing the authentication key using the code generation algorithm to generate an authentication code preferably includes an encoding process which converts the authentication key into an n-digit authentication code by applying a suitable hashing function to the authentication key, or possibly to the result of a logic function involving the authentication key and other data. A suitable hashing function may include, for example, MD5, SHA-1, SHA-224, SHA-256, SHA-384, or SHA-512. As will be appreciated, a hashing function converts an input, which in this instance is either the authentication key or the result of a logic operation involving the authentication key and other data, and provides a fixed length hash value output.

Where the code generation algorithm applies a hashing function which takes as the input the result of a logic operation involving the authentication key and other data, a suitable logic operation may include, for example, an XOR logic operation. However, it is possible that other logic operations may be used. The other data may be formed by appending data values such as a synchronisation counter value, and/or an identification code (such as the old PIN), and/or mode information for the user device. The synchronisation counter value may be a count value which is synchronised with a corresponding counter on the authentication system for generating or updating a new authentication key on the user device and the authentication system after an authentication process. Including an identification code in the other data with the logic operation involving the authentication key may assist with ensuring that the correct user is using the user device.

In one embodiment the user is required to input or enter the old PIN into the user device to activate the user device to perform the method.

Processing the value using the value verification code generation algorithm to generate a value verification code preferably includes an encoding process which converts the value into an m-digit value verification code by applying a suitable hashing function to the value, or possibly to the result of a logic operation involving the value and other data, such as the old PIN, input or entered by a user of the user device. Thus, the old PIN may be used in the authentication code generation algorithm and the value verification code generation algorithm. The logic operation used to generate the value verification code may also involve the authentication key or indeed a different secret key. An embodiment which involves the old PIN and/or the authentication key in the generation of the value verification code may thus generate a value verification code which may be processed by the authentication system to verify the value and authenticate the user device (via the authentication key) and/or the user (via the old PIN). Two purposes may thus then be served by the value verification code, namely, to verify the value and to authenticate the user device and/or the user.

Using the authentication code, the value and the value verification code to construct a message encrypting the value may include performing a logic or arithmetic operation including at least the authentication code and the value. However, in some embodiments the logic or arithmetic operation may additionally involve the value verification code.

The logic or arithmetic operation may include concatenating the value and value verification code to form a concatenated result comprising the value and the value verification code, and then adding the authentication code to the concatenated result using modulus arithmetic. In this instance, adding the authentication code to the concatenated result constructs the message encrypting the value and value verification code.

Preferably, the authentication code, the value and the value verification code are each formed as a respective sequence of digits from a digit set of X possible digits. In this respect, where used throughout this specification the term “digit” is to be understood to denote a number, character, symbol, or the like. It will be appreciated that a digit may be represented using multiple binary bits. For example, the numeral “9” may be represented in binary as “1001”. In this example, the digit is the numeral “9” selected from the set of ten digits “0” to “9”. The digit set of X possible digits may comprise digits from the ASCII character set (in other words, a digit set of 128 different digits), an extended ASCII character set (in other words, a digit set of 255 different digits), or a sub-set of ASCII characters, in which case, each digit may be represented as a 8-bit binary sequence, or a two character binary coded decimal sequence.

In embodiments where each respective sequence of digits comprises digits from a digit set of X possible digits and modulus arithmetic is used to construct the message, the modulus arithmetic may use modulus X arithmetic. Using modulus X arithmetic may ensure that a uniquely reversible (that is, decryptable) message is constructed for each encrypted value. In other words, the encrypted value may be uniquely decryptable to recover or reconstruct the value encrypted by the message. Hence, two different values encrypted by constructing a message using the same authentication code would result in different unique and reversible constructed messages.

In an embodiment, the constructed message is an N-digit message and thus has a “length” of N-digits. The authentication code may have the same length or a lesser length than that of the constructed message. Thus, for example, the authentication code may include an n-digit code where n=N.

Preferably, the value has a length which is less than the length of the authentication code, and the value verification code has a length which corresponds to the difference in the length of the authentication code and the length of the value so that the combined length of the value and the value verification code corresponds to the length of the authentication code. In this way, by selecting a suitable arithmetic or logic operation, the constructed message may have a length which corresponds with the length of the authentication code, and each digit of the constructed message may encrypt a respective digit of either the value or the value verification code. For example, assuming the authentication code has a length of n-digits, the constructed message may also have a length of n-digits, wherein the n-digits include i-digits encrypting the value, and m-digits encrypting the value verification code, and wherein n=i+m. In this example, because the length of the message corresponds to the combined length of the value and the value verification code, and thus has the same number of digits, each digit in the authentication code may be involved in a separate arithmetic operation (such as addition or subtraction) with a respective digit of the concatenated sequence to construct the message concealing the value and the value verification code. Alternatively, the message may be constructed by performing a logic operation (such as an XOR logic operation) including the authentication code, and the concatenated value and value verification code.

In another alternative, using the authentication code, the value and the value verification code to construct a message encrypting the value may involve performing a logic or arithmetic operation using only the authentication code and the value to encrypt the value, and then appending the value verification code to the encrypted value to complete the construction of the message. In this alternative, the value verification code may not be encrypted. In this instance, performing the logic or arithmetic operation may include an arithmetic operation which includes, for example, a modulus arithmetic operation involving only the authentication code and the value. As already described, the authentication code and the value may comprise a sequence of digits from a digit set comprising X digits, and the modulus arithmetic may use modulus X arithmetic. In this embodiment it is preferred that the authentication code and the value have the same length so that each digit in the authentication code may be, for example, added separately to a respective digit of the value using modulus arithmetic to thereby construct the message encrypting the value. In this instance, the message encrypting the value will include a portion which encrypts the value and an unencrypted portion comprising the value verification code.

Other methods of constructing the message are also possible. For example, instead of adding the authentication code to the concatenated sequence or to the value, constructing the message may involve subtracting either the concatenated sequence or the value from the authentication code, or vice versa. In an alternative to adding or subtracting, the message may be constructed as the result of a logic operation, such as a binary XOR operation (exclusive OR) involving the authentication code, value and value verification code, or the authentication code and the value, or binary or other representations thereof. For example, a binary representation of the value and the value verification code may be concatenated, and the resulting concatenated sequence may then be XOR-ed with a binary representation of the authentication code in order to construct the message. In another example, a binary representation of the value may be combined with a binary representation of the authentication code using binary XOR to provide a logic result, and the value verification code then appended to the result. It will be appreciated that other methods of constructing the message, for example using different logic or arithmetic operations, are also possible.

On receipt of the message by the authentication system, the authentication system generates expected authentication code by processing the same authentication key and code generation algorithm as used by the user device to construct the message. The authentication system then determines or derives the value and the value verification code contained in the message by applying a reverse logic and/or arithmetic operation to that performed by the user device to construct the message. The authentication system then processes the determined or derived value using the same value verification code generation algorithm to generate an expected value verification code which is compared to the value verification code determined or derived from the message. If the derived value verification code matches the expected value verification code, this verifies the value and indicates that the authentication code used to encrypt the value was correct, thus authenticating the user device and/or the user.

In some embodiments information identifying the user device and/or the user may also be communicated to the authentication system, either within the message or independently of the message. For example, where the authentication system authenticates multiple user devices, the identifying information may be used to determine which authentication key the user device should have used to generate the authentication code.

The method may also include authenticating the authentication system to the user device and/or the user, prior to communicating the constructed message to the authentication system. In this way, the user may be able to verify the authenticity of the authentication system prior, to communicating the message to the authentication server. The method may include, for example:

the user device receiving an authentication response that has been generated at the authentication system using a response generation algorithm based on a server authentication key, the response being generated in response to receiving a authentication request from the user and/or the user device;

the user device generating, using the same response generation algorithm, an expected authentication response based on the server authentication key;

the user device comparing the expected authentication response to the authentication response; and

in the event that the expected authentication response correlates with the received authentication response, prompting the user to enter a value for encryption.

The server authentication key may be the same as the authentication key used to encrypt the value or it may be a different key. Similarly, the response generation algorithm may be the same as the code generation algorithm, or it may be a different algorithm.

According to another aspect, the present invention provides a method of verifying a value communicated to an authentication system via a communications network, the authentication system storing an authentication key associated with a user device, a code generation algorithm, and a value verification code generation algorithm, the method including:

the authentication system receiving a message constructed by a user device;

the authentication system processing the authentication key using the code generation algorithm to generate an expected authentication code;

the authentication system processing the message using the expected authentication code to determine a received value and a received value verification code;

the authentication system processing the received value using the value verification code generation algorithm to generate an expected value verification code;

the authentication system comparing the expected value verification code with the received value verification code; and

in the event that the expected value verification code correlates with the received value verification code, verifying the received value and authenticating the user device and/or the user.

The method may allow the authentication system to both verify the received value, and authenticate the user device and/or the user by processing a single message.

The authentication system may store plural authentication keys associated with different user devices. Further information transmitted to the authentication system, such as a label, may be used to determine which authentication key should be associated with the user device and/or the user. By way of example, a label may include a credit card number, account number, user name, or the like.

Processing the received value using the value verification code generation algorithm to generate the expected value verification code may further include processing either the authentication key or a different secret key. In this instance, the expected value verification code would correlate with the received value verification code only if the user device used the correct key. The value verification code therefore would serve the two purposes, namely, verifying the value and authenticating the user device and/or the user. In this respect, a “correlation” between the expected value verification code and the received value verification code may mean that the two values are identical, or that they have an expected relationship.

Processing the message may include performing a logic or arithmetic operation using the expected authentication code. For example, performing the logic or arithmetic operation may include subtracting the expected authentication code from at least part of the message using modulus arithmetic.

The authentication code may be subtracted from the entire message, or where the value verification code has been appended to the encrypted PIN, the value verification code may be de-appended from the message before subtracting the authentication code.

The expected authentication code and the message may be comprised of digits selected from a digit set comprising X possible digits, and the modulus arithmetic may use modulus X. In an embodiment, each digit of the expected authentication code may be subtracted separately from a respective digit of the message using the modulus arithmetic.

To ensure that the correct user is operating the user device, processing the authentication key using the code generation algorithm to generate an expected authentication code may further include processing a PIN associated with the user device and stored at the authentication system. At the user device end, to generate the correct authentication code, the user would need to enter the correct PIN.

Similarly, processing the received value using the value verification code generation algorithm to generate an expected value verification code may further include processing a PIN associated with the user device and stored at the authentication system. The same PIN may be used in both the code generation algorithm and the value verification code generation algorithm.

As described above, the value may be a replacement or new PIN associated with the user device, for storage at the authentication system. Also, so that the user device can authenticate the authentication system before the message is communicated, the method may include, before receiving the message:

the authentication system receiving an authentication request associated with the user device;

the authentication system generating an authentication response using a response generation algorithm based on the authentication key; and

the authentication system communicating the authentication response to the requestor.

The requestor may include a user device or another device such as a network connected computer.

According to another aspect of an embodiment of the present invention there is provided a method of communicating a value input into a user device to an authentication system via a communications network, the user device storing a first authentication key, a first code generation algorithm, and a first value verification code generation algorithm, and the authentication system storing a second authentication key, a second code generation algorithm, and a second value verification code generation algorithm, the method including:

the user device processing the first authentication key using the first code generation algorithm to generate an authentication code;

the user device processing the value using the first value verification code generation algorithm to generate a value verification code;

the user device using the authentication code, the value and the value verification code to construct a message encrypting the value;

communicating the message to the authentication system;

the authentication system receiving the message;

the authentication system processing the second authentication key using the second code generation algorithm to generate an expected authentication code;

the authentication system processing the message using the expected authentication code to determine a received value and a received value verification code;

the authentication system processing the received value using the second value verification code generation algorithm to generate an expected value verification code;

the authentication system comparing the expected value verification code with the received value verification code; and

in the event that the expected value verification code correlates with the received value verification code, verifying the received value and authenticating the user device.

According to another aspect, the present invention provides a user device including:

an input for receiving a value;

an output for outputting a message;

a processor;

a memory storing an authentication key, a code generation algorithm, and a value verification code generation algorithm; and

software resident in memory accessible to the processor, the software including a series of instructions executable by the processor to carry out a method of encrypting the value, input into the user device including:

processing the authentication key using the code generation algorithm to generate an authentication code;

processing the value using the value verification code generation algorithm to generate a value verification code;

using the authentication code, the value and the value verification code to construct a message encrypting the value, and

outputting the message, the message for communicating to an authentication system via a communications network for processing by the authentication system to determine and verify the value, and authenticate the user device.

The software may additionally perform the steps of any of the methods described above. In an embodiment, the user device includes a smart card including an n-digit display as the output. In this embodiment, the authentication code may be an n-digit sequence, the value may have a sequence length less than the sequence length of the authentication code, and the value verification code may have a sequence length which corresponds to the difference between the sequence length of the authentication code and the sequence length of the value. This embodiment may reduce the processing power required to encrypt the value, while using all of the digits in the display. The authentication code, the value and the value verification code may all have a sequence length of less than n-digits.

According to another aspect, the present invention provides an authentication system including:

a communications port;

a processor;

a memory storing an authentication key, a code generation algorithm, and a value verification code generation algorithm; and

software resident in memory accessible to the processor, the software including a series of instructions executable by the processor to carry out a method including:

receiving a message;

processing the authentication key using the code generation algorithm to generate an expected authentication code;

processing the message using the expected authentication code to determine a received value and a received value verification code;

processing the received value using the value verification code generation algorithm to generate an expected value verification code;

comparing the expected value verification code with the received value verification code; and

in the event that the expected value verification code, correlates with the received value verification code, verifying the received value and authenticating the user device and/or the user.

The software may additionally perform the steps of any of the methods described above. The present invention also extends to a system including a user device and an authentication system as described above, the software itself, including a series of instructions executable by a processor to carry out any one of the methods described above, and a computer readable media containing the software.

### BRIEF DESCRIPTION OF THE DRAWINGS

Embodiments of the present invention will now be described, by way of example only, with reference to the accompanying drawings. It is to be understood that the particularity of the drawings does not supersede the generality of the preceding description of the invention.

FIG. 1 is a schematic diagram of an example network including authentication systems and user devices according to an embodiment of the invention;

FIG. 2 is a lower level block diagram of an authentication system of FIG. 1;

FIG. 3 is a lower level block diagram of a user device of FIG. 1;

FIG. 4 is a flow chart of an embodiment of a method of encrypting a value at the user device of FIG. 3 and verifying the value at the authentication system of FIG. 2; and

FIG. 5 is a flow chart of an embodiment of a method of authenticating an authentication system.

### DETAILED DESCRIPTION OF AN EMBODIMENT

### Example of a Network

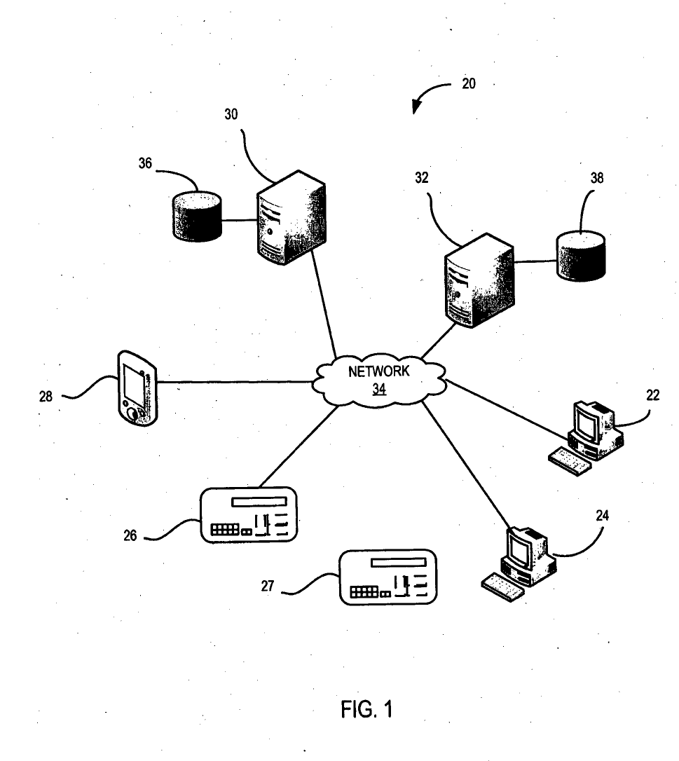

Embodiments of the present invention can be realised over a communications network, an example of which is shown in FIG. 1. The network 20 shown in FIG. 1 includes one or more user devices and one or more authentication systems. In this example, the user devices include personal computers (PCs) 22 and 24, smart cards 26 and 27, and a hand held device 28. The authentication systems include servers 30 and 32. As shown, user devices 22 to 28 and authentication systems 30, 32 are connected to support electronic data communication via the communications network 34.

The transfer of data over the network 34 may involve wired or wireless data communication. The authentication systems 30 and 32 can facilitate the transfer of data over the network 34 and one or more databases, such as databases 36 and 38 respectively.

It will be appreciated that embodiments of the invention may be realised over different networks, such as a MAN (metropolitan area network), WAN (wide area network), LAN (local area network) or the internet. Also, embodiments need not take place over a network, since some embodiments could occur entirely on a user device or authentication system.

### Example of an Authentication System

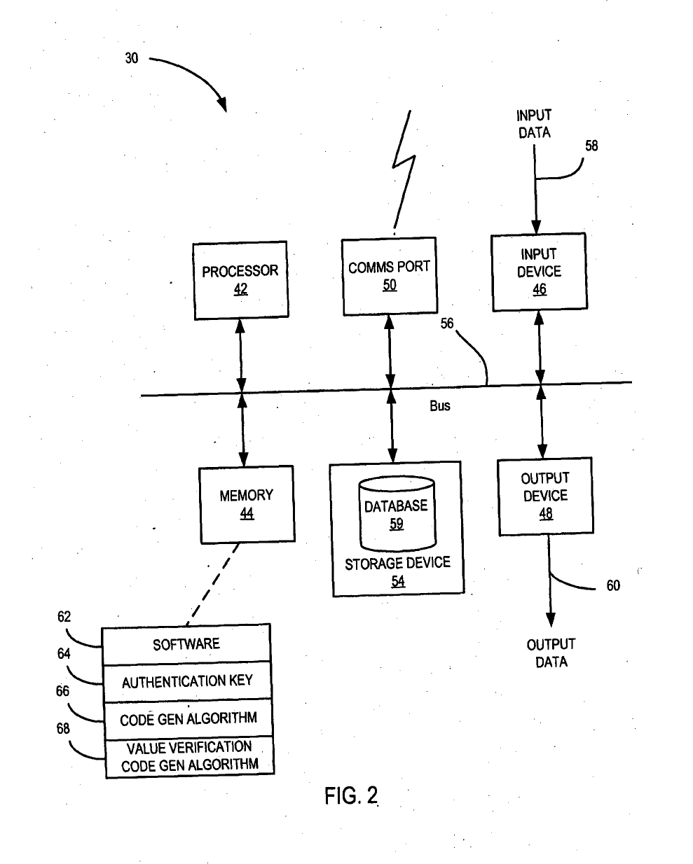

FIG. 2 shows a block diagram of an authentication system 30 according to an embodiment of the present invention. The authentication system 30 includes a processor 42, a memory 44, at least one input device 46, at least one output device 48, a communications port 50 and a storage device 54. As is shown, the components of the authentication system 30 are coupled via a bus or group of buses 56, such as data, address and/or control buses.

The processor 42 may include more than one processing device, for example to handle different functions within the authentication system 30. The memory 44 may include any suitable memory device and include, for example, volatile or non-volatile memory, solid state storage devices, magnetic devices, etc. The memory 44 stores a computer software program 62 for execution by the processor 42.

In this embodiment, the memory 44 also stores at least one authentication key 64. Multiple authentication keys may be stored in the memory 44, or the database 59, each authentication key associated with a different user device. For example, if the authentication system 30 is for a financial institution, each authentication key 64 may be associated with a particular account, or account holder.

Alternatively, the authentication key 64 may be stored externally of the authentication system 30 and may be accessible to the authentication system 30 via the communications network 34.

The memory 44 also stores a code generation algorithm 66 for generating an authentication code, and a value verification code generation algorithm 68 for generating a value verification code. Further details of these algorithms and the authentication key will be given below.

Input device 46 receives input data 58 and may include, for example, a keyboard, a mouse or other pointer device, a trackball, joystick or touch-screen, a microphone, a data receiver or antenna such as a modem or wireless data adaptor, data acquisition card, etc. An input device 46 may be operable by a user to enter input data 58, or it may receive data from another input data source.

Output device 48 produces or generates output data 60. Output device 48 may include a display device, a set of audio speakers, a printer, a port (for example a USB port), a peripheral component adaptor, a data transmitter or antenna such as a modem or wireless network adaptor, etc.

The storage device 54 can include any form of data or information storage means, for example, volatile or non-volatile memory, solid state storage devices, magnetic devices, etc. A file system and files may be stored on the storage device 54. The storage device 54 may house at least one database 59.

The communications port 50 allows the authentication system 30 to communicate with other devices via a hard wired or wireless network, such as network 34. Suitable communications ports may use an IEEE802.11 based wireless interface, a general packet radio service (GPRS) compatible interface, a wireless application protocol (WAP) compatible interface, a Bluetooth interface, an optical interface (such as an IrDA interface), a ZigBee interface, a universal serial bus (USB) interface or the like, or an radio frequency identification (RFID) induction based communication interface.

In use, the authentication system 30 can be adapted to allow data to be stored in and/or retrieved from the database 59 via the communication port 50.

The authentication system 30 may include any form of terminal, server processing system, specialised hardware, computer, computer system or computerised device, personal computer (PC), mobile or cellular telephone, mobile data terminal, portable computer, Personal Digital Assistant (PDA), pager, smart card or any other type of device.

### Example of a User Device

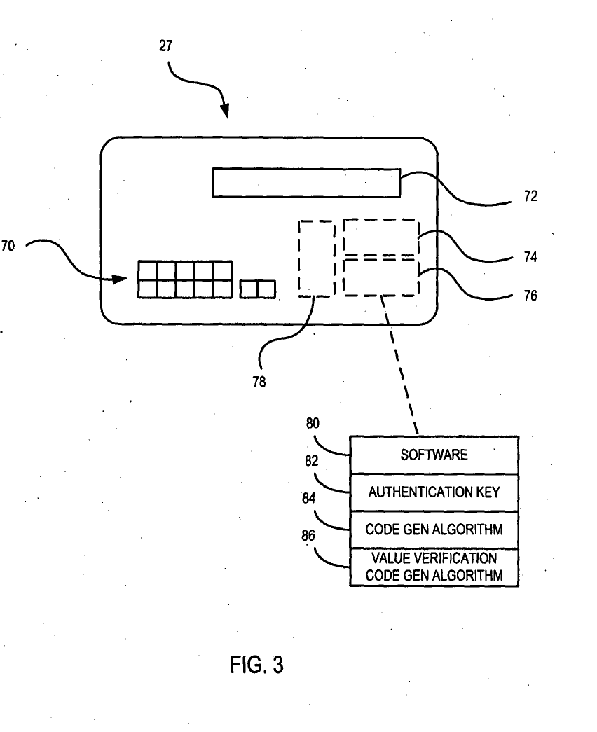

FIG. 3 shows a block diagram of a user device 27 according to an embodiment of the present invention. As shown, in this example the user device 27 is a smart card including an input in the form of a keypad 70, an output in the form of a display 72, a processor 74, a memory 76 and a power supply 78.

In this example, the keypad 70 is a 12 button keypad containing the digits 0 to 9, and two additional buttons for performing selections and controlling operation of the user device 27. A user may input a value, such as a PIN into the user device 27 using the keypad 70. The display 72 is an 8-digit alphanumeric LCD display.

The processor 74 is a microprocessor or microcontroller, for executing a computer software program 80 resident in the memory 76. An example of a suitable processor 74 is the 6502, ARM, Motorola 6800, Texas Instruments MSP430. The power supply 78 may include a battery or an induction coil, to supply electrical power to the processor 74 and other functional components of the user device 27.

The memory 76 includes read-only memory (ROM) (such as an EPROM or EEPROM) on-board the processor 74. However, it is possible that the memory 76 may be external to the processor 74. The memory 76 may also include a random access memory (RAM) to provide working memory for the processor 74. The memory 76 stores a computer software program 80 for execution by the processor 74.

The smart card may also function as a credit card or debit card, and may include a magnetic stripe, integrated circuit or other components for storing further information associated with the card. This information may be readable by an appropriate reader for forwarding to the authentication system 30 (ref. FIG. 2). The smart card may also include a communications port, as described above, for data communication with an authentication system 30 (ref. FIG. 2).

Although the above described example of a user device 27 is in the form of a smart card, it is of course possible that further embodiments may be implemented in other forms. For example, the user device may include a mobile device equipped with suitable processing infrastructure, such as a mobile phone, a personal digital assistant (PDA), a laptop computer, a hand-held computer, or the like. Similarly, the user device may include a desktop computer programmed with an executable software program. Thus, it will be appreciated that a user device may include a number of different hardware ‘platforms’.

The memory 76 of the user device 27 stores an authentication key 82. The authentication key 82 may be for accessing a particular service, such as an electronic data interchange service (for example an on-line banking service, share trading service, an on-line shopping service, or the like), a computer network service (for example a network log-on service), a communications service (for example an email service or a messaging service), a membership based service (for example an on-line forum, a car-rental service, or a health service), a security service (for example a building access service), or the like.

Alternatively, the authentication key 82 may allow access to plural different services. In an embodiment, the memory 76 may store multiple authentication keys, each for accessing a particular service or services. The user may be required to select a particular service to indicate to the user device 27 which authentication key is to be used.

The authentication key 82 is a secret key, such as a seed, code or data sequence, associated with the user device 27. In this example, the authentication key 82 is a 256-bit shared key, stored in the memory 76 of the user device 27. The authentication key 82 is the same as the authentication key 64 stored in the memory 44 of the authentication system 30 for the particular service.

Two algorithms are also stored in the memory 76. These include a code generation algorithm 84 and a value verification code generation algorithm 86 that are the same as the algorithms 66 and 68 stored at the authentication system 30. An example of a suitable code generation algorithm 84 and a suitable value verification code generation algorithm 86 are presented below.

### Example Code Generation Algorithm

The code generation algorithm 66 and 84 in this example is:

<STEP1> = ENCODE(

<CODE LENGTH>, HASH(

<MODE SECRET> XOR (

<MODE COUNTER> &
<MODE TYPE> &
<MODE INSTANCE> &
<PIN>

)

)

)

Where <STEP1> is the authentication code, <CODE LENGTH> is the length of the authentication code to be generated, <MODE SECRET> is the authentication key for an identified mode type, <MODE COUNTER> is a counter that is synchronised between the user device and the authentication system, <MODE TYPE> is a number representing the particular mode type, <MODE INSTANCE> is an instance of the mode, for example if the user device has more than one mode with the same <MODE TYPE> value (for example, two one-time-password (OTP) modes), <PIN> is an existing PIN (that is, the old PIN) associated with the user device 27 or the user, XOR is the logical exclusive OR operation, and “&” indicates appending.

In this example, the code generation algorithm 66, 84 may use different “modes” associated with different algorithms for encrypting the value (which in this example, is a new PIN). For example, the “mode” may include a one time password mode, a two way response mode, or a mode that takes into account user input data. The mode may depend on the service that is being accessed, and will correspond with the mode, and thus the algorithms, used at the authentication system. It is possible that the code generation algorithm 66, 84 may operate in only a single mode, in which case the mode parameters MODE TYPE and MODE INSTANCE may be omitted.

HASH may be any suitable hashing function, for example MD5, SHA-1, SHA-224, SHA-256, SHA-384 or SHA-512. In this example, the hashing function is SHA-256 function. ENCODE may also be any encoding function. In this example ENCODE converts the 256 bit result (DATA) of the HASH to an authentication code having a length of <CODE LENGTH>, using the following equation:

Digit N=DATA[(48+(N*8)) . . . (48+((N+1)*8)−1)] MOD 10d

Where N equals 0 to (<CODE LENGTH>−1), and DATA is the 256-bit result of the HASH function, which in this example is a SHA-256 hash function. It will of course be appreciated that the above equation is not intended to be a limiting example and thus that other functions for encoding the HASH may be used.

In the below example, <CODE LENGTH>=3 and the result of the 256-bit HASH (in hexadecimal) is shown in Table 1:

TABLE 1
Byte number

| | | | | | | | | | | | | | | | |
|---|---|---|---|---|---|---|---|---|---|---|---|---|---|---|---|
| 00 | 01 | 02 | 03 | 04 | 05 | 06 | 07 | 08 | 09 | 10 | 11 | 12 | 13 | 14 | 15 |

Byte Value

| | | | | | | | | | | | | | | | |
|---|---|---|---|---|---|---|---|---|---|---|---|---|---|---|---|
| DD | 09 | 36 | E7 | 7A | 1C | 88 | 5B | E4 | 70 | 2C | D4 | 67 | 0B | 31 | D5 |

Byte number

| | | | | | | | | | | | | | | | |
|---|---|---|---|---|---|---|---|---|---|---|---|---|---|---|---|
| 16 | 17 | 18 | 19 | 20 | 21 | 22 | 23 | 24 | 25 | 26 | 27 | 28 | 29 | 30 | 31 |

Byte Value

| | | | | | | | | | | | | | | | |
|---|---|---|---|---|---|---|---|---|---|---|---|---|---|---|---|
| EF | 54 | A4 | 07 | 12 | C5 | 7D | 72 | 45 | 23 | CC | FA | 0A | 19 | 4F | 92 |

The ENCODE function converts the 256-bit result (DATA) of the HASH to an authentication code having a length of 3-digits (Digit 0, Digit 1, Digit 2), using the following equations:

Digit 0=Data[48 . . . 55] MOD 10d=88h MOD 10d=136d MOD 10d=6

Digit 1=Data[56 . . . 63] MOD 10d=5Bh MOD 10d=91d MOD 10d=1

Digit 2=Data[64 . . . 71] MOD 10d=E4h MOD 10d=228d MOD 10d=8

The result of ENCODE and thus <STEP1> would be the three digit value:

<STEP1>=618.

In other words, in this example the authentication code=618. In this instance the ENCODE function converts the 256-bit authentication key into an n-digit authentication code, which in this example is a 3-bit authentication code, by applying the hashing function HASH. A 3-bit authentication code may be used to construct a 3-bit message encrypting a 2-bit value and a 1-bit value verification code, or a message encrypting a 3-bit value.

In this example, the counter (MODE COUNTER) is a count value which is synchronised between the user device 27 and the authentication system to enhance security. By way of example, each time a message is communicated between the user device and authentication system to authenticate one or the other, the counter is incremented, and the authentication key is incremented using the counter to thereby generate a new authentication key. The counter is optional, and alternatively, the same authentication key could be used each time a value is encrypted.

### Example Value Verification Code Generation Algorithm

The value verification code (VVC) generation algorithm 68 and 86 in this example is:

<VVC> = ENCODE(

8 − <PIN LENGTH>, HASH(
<MODE SECRET> XOR (
<MODE COUNTER> &
<MODE TYPE> &
<MODE INSTANCE > &
<PIN> &
<SEPARATOR> &
<NEW PIN>
)

)

)

Where <PIN LENGTH> is the length of the value being encrypted, <MODE SECRET>, <MODE COUNTER>, <MODE TYPE>, <MODE INSTANCE>, <PIN>; HASH, ENCODE, XOR and “&” are as described above, <SEPARATOR> is a constant, in this case the hexadecimal value “FE”, and <NEW PIN> is the value being encrypted. In the present example, the separator is included simply to provide a convenient mechanism for partitioning the PIN (that is, the old PIN) and the NEW PIN.

It will be appreciated that the above examples are only two examples of suitable algorithms for generating an authentication code and a value verification code respectively, and that other algorithms could be used. For example, different or fewer variables may be involved in the XOR step and the PIN (that is, the old PIN) need not be used. Furthermore, if the user device 27 operates in, a single mode, values such as <MODE COUNTER>, <MODE TYPE>, <MODE INSTANCE> would not be applicable. Furthermore, other information, such as an account number, or additional user input values may be used.

Also, a different secret key may be used in the value verification code generation algorithm than is used in the code generation algorithm, or indeed the value verification code generation algorithm may not use a secret key at all and may instead generate the value verification code using another approach.

### Example of Encrypting a Value

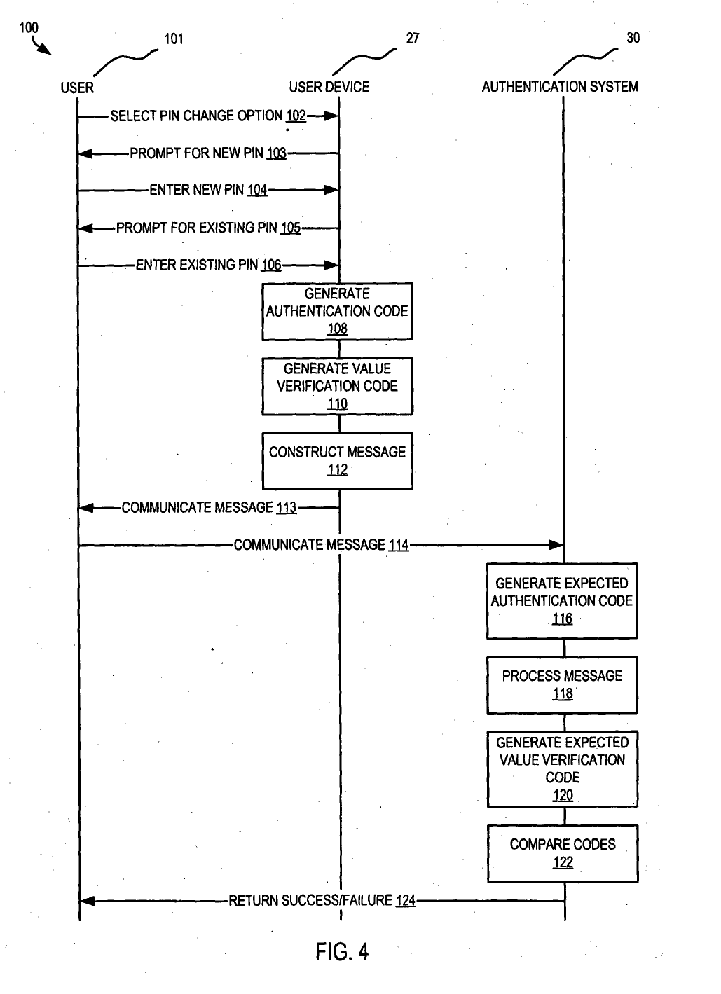

FIG. 4 illustrates a method 100 of encrypting a value input into the user device 27 according to an embodiment of the invention. In this example, the value is a replacement PIN for storage at the authentication system 30.

With reference now to FIG. 3 and FIG. 4, at step 102, the user 101 selects a PIN change option using the keypad 70 of the user device 27. Selection of the PIN change option may require the user 101 to enter an authentication response generated by the authentication system 30, as will be described below, to enable the user device 27 to authenticate the authentication system 30. However, this step is optional as the value communicated is encrypted in any case.

At step 103, the user device 27 prompts the user 101 to enter a replacement PIN. At step 104, the user 101 enters the replacement or new PIN into the keypad 70, for example the sequence of digits “9876” representing the replacement or new PIN. To ensure that the replacement or new PIN was correctly entered, the software 80 may prompt the user 101 to re-enter the replacement PIN.

The software 80 then prompts the user 101 to enter the existing PIN (that is, the old PIN) at step 105, which the user 101 enters at step 106. For example, the existing PIN may be the sequence of digits “1234”.

At step 108 the software 80 processes the authentication key 82 using the code generation algorithm 84 to generate an authentication code. In this example, the following hexadecimal values are used:

<MODE SECRET> =
4B 50 13 07 66 4D CB 01 FF B6 B3 35 10 7B 42 E6 FC A6 B8
57 51 AE 72 7435 9E 69 79 15 35 5B 70
<CODE LENGTH> = 8
<MODE COUNTER> = 00 00 01
<MODE TYPE> = 13
<MODE INSTANCE> = 00
<PIN> = 31 32 33 34

In this example, as previously described, <MODE TYPE>, <MODE INSTANCE>, <MODE COUNTER> are optional and have been included merely to present examples of additional data which may be involved in the code generation algorithm.

It is also to be noted that in this example, the value (which in this instance is the existing PIN) of “1234” is converted into its ASCII representation in hexadecimal format. Such an approach allows, for example, alphanumeric values (such as alphanumeric PINs), and possibly non-alphanumeric values, to be used.

In this example, the above parameters are then processed by the code generation algorithm 84 as follows:

<STEP1> = ENCODE(

<CODE LENGTH>, HASH(

<MODE SECRET> XOR (

<MODE COUNTER> &
<MODE TYPE> &
<MODE INSTANCE> &
<PIN>
)

)

)

<MODE COUNTER> & <MODE TYPE> & <MODE INSTANCE> &
<PIN> =
00 00 01 13 00 31 32 33 34
<MODE SECRET> XOR (<MODE COUNTER> & <MODE TYPE> &
<MODE INSTANCE> & <PIN>) =
4B 50 12 14 66 7C F9 32
CB B6 B3 35 10 7B 42 E6
FC A6 B8 57 51 AE 72 74
35 9E 69 79 15 35 5B 70
HASH(<MODE SECRET> XOR (<MODE COUNTER> & <MODE
TYPE> & <MODE INSTANCE> & <PIN>)) =
9A 4B 42 FD 17 76 67 F8
54 9F 5B D2 07 BC 7B 77
B2 3D 6F 49 5D A9 F7 5C
F5 FF 86 C8 5C 97 F9 68
ENCODE(<LENGTH>, HASH(<MODE SECRET> XOR (<MODE
COUNTER> & <MODE TYPE> & <MODE INSTANCE> & <PIN>))) =
38491078

The authentication code is thus generated as the n-digit code (where n=8):

Authentication Code=38491078

At step 110, the software 80 processes the value using the value verification code generation algorithm 86 to generate a value verification code.

The values for <MODE SECRET> (that is, the authentication key), <MODE

COUNTER>, <MODE TYPE>, <MODE INSTANCE> and <PIN> are as given above. In addition,

<SEPARATOR> = FE
<NEW PIN> = 39 38 37 36
<PIN LENGTH> = 4

Again, in this example, the value of “9876”, which in this example is the new PIN, is been converted into its ASCII representation in hexadecimal format (that is, “39 38 37 36”) for processing. The above parameters are then processed by the value verification code generation algorithm 86 as follows:

<VVC> = ENCODE(

8 − <PIN LENGTH>, HASH(

<MODE SECRET> XOR (

<MODE COUNTER> &
<MODE TYPE> &
<MODE INSTANCE> 4
<PIN> &
<SEPARATOR> &
<NEW PIN>
)

)

)

<MODE COUNTER> & <MODE TYPE> & <MODE INSTANCE>
& <PIN> & <SEPARATOR> & <NEW PIN> =
00 00 01 13 00 31 32 33 34 FE 39 38 37 36
<MODE SECRET> XOR (<MODE COUNTER> & <MODE TYPE> &
<MODE INSTANCE> & <PIN> & <SEPARATOR> & <NEW PIN>) =
4B 50 12 14 66 7C F9 32
CB 48 8A 0D 27 4D 42 E6
FC A6 B8 57 51 AE 72 74
35 9E 69 79 15 35 5B 70
HASH(<MODE SECRET> XOR (<MODE COUNTER> & <MODE
TYPE> & <MODE INSTANCE> & <PIN> & <SEPARATOR> & <NEW
PIN>)) =
CF F4 47 C9 4C 36 CB 66
69 BA 3A B6 61 7C AD EE
B6 98 63 19 DA 2A 19 71
12 40 6D 08 C1 C3 45 18
ENCODE(4, HASH(<MODE SECRET> XOR (<MODE COUNTER> &
<MODE TYPE> & <MODE INSTANCE> & <PIN> & <SEPARATOR>
& <NEW PIN>))) =
3256

The value verification code is thus generated as the m-digit code (where m=4):

Value Verification Code=3256

At step 112, the software 80 uses the authentication code (38491078), the value (9876) and the value verification code (3256) to construct a message for encrypting the value (9876). In this example, an arithmetic operation involving all three values as operands is used to construct the message. In this operation, the value and value verification code are concatenated to provide a concatenated sequence (98763256), and the authentication code is then added, using modulus 10 arithmetic, to the concatenated sequence, with each digit being added separately as follows:

<MESSAGE>=<STEP1> ADD (<NEW PIN> & <VVC>)

TABLE 2

| | | | | | | | | |
|---|---|---|---|---|---|---|---|---|
| <STEP 1> | 3 | 8 | 4 | 9 | 1 | 0 | 7 | 8 |
| <NEWPIN> | 9 | 8 | 7 | 6 | | | | |
| <VVC> | | | | | 3 | 2 | 5 | 6 |
| <MESSAGE> | 2 | 6 | 1 | 5 | 4 | 2 | 2 | 4 |

Where ADD is a modulus 10 addition operation.

In this example, it is to be noted that the value verification code <VVC> is concatenated to the end of the 4-digit value <NEW PIN>, however, it is also possible that the value verification code could be concatenated at the beginning of the value, or could be separated from the value by other digits. Indeed, the value verification code could be appended to the end of the message, rather than being added to the authentication code <STEP 1>.

Also, in this example, the value verification code <VVC> is chosen to have a sequence length which corresponds to the difference between the length of the authentication code <STEP 1>, which in this example is 8-digits, and the length of the value <NEW PIN>, which in this example is 4-digits. Hence, in this example the value comprises 4 digits, the authentication code comprises 8 digits and the value verification code comprises 4 digits. Similarly, if the value <NEW PIN> comprised 6 digits and the authentication code comprised 8 digits, the value verification code <VVC> may comprise 2 digits. It will be appreciated that the number of digits in the authentication code <STEP 1> compared with the concatenated value and value verification code may be different. It is desirable, however, that the authentication code be at least equal to, if not longer in length than the value.

Further, this example uses modulus 10 addition, as the authentication code, value and value verification code are comprised of a sequence of digits selected from a digit set comprising 10 digits (0, 1, 2, 3, 4, 5, 6, 7, 8 and 9). However, if the digits were selected from a digit set comprising X digits, a message could be constructed using a modulus X arithmetic operation, such modulus X addition or subtraction.

The constructed message (that is, 26154224) is then communicated or output to the user 101 at step 113, for example, the message may be output for display on the 8-digit display 72 of the user device 27. The message (26154224) is for communicating to an authentication system 30 via a communications network 34 for processing by the authentication system 30 to determine and verify the value (9876), and authenticate the user device 27 and/or the user 101.

At step 114 the user 101 communicates the message to the authentication system 30 by a suitable means. If the user 101 has access to a personal computer 24, communicating the message to the authentication system 30 the may involve the user 101 manually entering the message into the personal computer 24 for transmission via the network 34 to the authentication system 30. In other alternatives, the user device 27 may be network connected (for example if it is a mobile phone or PDA), and directly transmit the message to the authentication system 30 without further user input. In yet other alternatives, the message may be read from the user device 27 (for example, a credit card) by another device, such as an automatic teller machine, and transmitted to the authentication system 30. In these alternatives, the user 101 need not know the value of the message.

Together with the message, the user 101 (or the user device 27) communicates to the authentication system 30 additional information associated with the user device 27, such as a credit card number, account number, account name or the like. Such information may be used to identify the user and/or the card claiming to communicate the message, and thus determine which authentication key and PIN is associated with the user device 27. However, it is not essential that the additional information be communicated with the message, since it may be provided either before or after the message has been communicated.

### Example of Verifying a Value

In this example, the authentication system 30 receives the message via the communications port 50. The authentication system 30 uses the additional information to determine which authentication key and PIN is associated with the user device 27 and to retrieve those to process the received message to verify the value and authenticate the user 101 and/or user device 27.

Software 62 at the authentication system 30 processes the authentication key 64 at step 116 using the code generation algorithm 66 to generate an expected authentication code <STEP 1#>. This algorithm repeats the steps of the code generation algorithm 84 performed at the user device 27, as described above. If the authentication key 82 used by the user device 27 was the same as the authentication key 64 used by the authentication system 30 the same authentication code (e.g., “38491078”) should be obtained. The authentication system 30 then processes the message (e.g., “26154224”) at step 118 using the expected authentication code (e.g., “38491078”) to derive a received value <NEW PIN#> and a received value verification code <VVC#>.

In this example, processing the message involves subtracting the expected authentication code from the message using modulus 10 arithmetic to decode the message as follows:

<NEW PIN#> & <VVC#>=<MESSAGE> SUBTRACT <STEP 1#>

TABLE 3

| | | | | | | | | |
|---|---|---|---|---|---|---|---|---|
| <MESSAGE> | 2 | 6 | 1 | 5 | 4 | 2 | 2 | 4 |
| <STEP 1#> | 3 | 8 | 4 | 9 | 1 | 0 | 7 | 8 |
| <NEW PIN#> & <VVC#> | 9 | 8 | 7 | 6 | 3 | 2 | 5 | 6 |

In this example, modulus 10 subtraction is used since this is the reverse operation (that is, modulus 10 addition) to that applied by the user device 27 to construct the message.

In the above example, <NEW PIN#> is the new PIN value derived from the message by the authentication system 30, <VVC#> is the derived value verification code, and <STEP 1#> is the expected authentication code generated by the authentication system 30.

In this example, each digit of the expected authentication code <STEP 1#> is subtracted separately from a respective digit of the received message using modulus 10 arithmetic. Thus, in the present case, the authentication system 30 thereby determines a received value of “9876” and a received value verification code of “3256”.

The sequence length of the value and value verification code may be predetermined, so that the authentication system 30 can determine which digits of <NEW PIN#> & <VVC#> are associated with the value ends and which digits are associated with the value verification. Alternatively, the length may be communicated to the authentication system 30 with the message, to allow for variable length PINs.

At step 120, the software 62 at the authentication system 30 processes the received value “9876” using the value verification code generation algorithm 68 to generate an expected value verification code <VVC_EXP>. This algorithm repeats the steps of the value verification code generation algorithm 86 performed at the user device 27, as described above. Provided the message has been transmitted correctly, the same value verification code “3256” should be obtained. At step 122 the software 62 compares the expected value verification code <VVC_EXP> with the received value verification code <VVC#>. In the event that the two codes correlate, the authentication system 30 verifies the received value <VVC#> and authenticates the user device 27 and/or the user 101. In the event that the value verification code <VVC#> is valid, the authentication system 30 will replace the existing PIN “1234” stored in memory 44 or database 59 with the replacement PIN “9876”, thereby updating the PIN associated with the user device 27. If the two codes do not correlate, the PIN is not updated. At step 124 the authentication system 30 communicates to the user device 27 that the PIN has been updated.

### Example of Authenticating the Authentication System

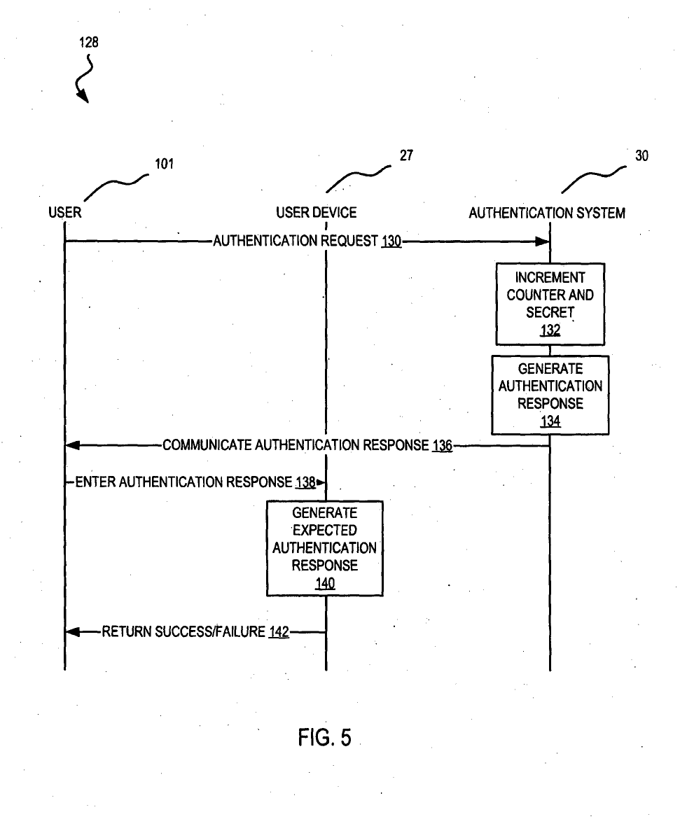

As mentioned above, selection of the PIN change option may require the user 101 to enter an authentication response generated by the authentication system 30. An example of such an authentication response will now be described with reference to FIG. 5. As previously described, this authentication method is optional. Other methods could be used to authenticate the authentication system 30 to the user device 27, or, as the value is sent encrypted, the authentication system 30 need not be authenticated at all.

In the method 128 shown in FIG. 5, at step 130 the user communicates an authentication request to the authentication system 30. The authentication request may be communicated via the user device 27, or another device such as a network connected computer or automatic teller machine. At step 132, the software 62 at the authentication system 30 increments the counter using, for example, binary coded decimal addition, and increments the authentication key using the new counter as follows.

<MODE COUNTER> = <MODE COUNTER> BCDADD 1
<MODE SECRET> = HASH(

<MODE SECRET> XOR (

<MODE COUNTER> &
<MODE TYPE> &
<MODE INSTANCE>

)

)

For example:

<MODE COUNTER> = 00 00 00
<MODE TYPE> = 10
<MODE INSTANCE> = 00
<MODE SECRET > =
D1 B9 1D 2C F8 2A 72 28
AA F6 6D 2C 3E 49 58 79
1E 78 C7 CE 53 81 DE 00
79 2F BD B6 C3 62 2F BB
<MODE COUNTER> = <MODE COUNTER> + 1 = 00 00 01
<MODE COUNTER> & <MODE TYPE> & <MODE INSTANCE> =
00 00 01 10 00
<MODE SECRET> XOR (<MODE COUNTER> & <MODE TYPE> &
<MODE INSTANCE>) =
D1 B9 1C 3C F8 2A 72 28
AA F6 6D 2C 3E 49 58 79
1E 78 C7 CE 53 81 DE 00
79 2F BD B6 C3 62 2F BB
HASH(<MODE SECRET> XOR (<MODE COUNTER> & <MODE
TYPE> & <MODE INSTANCE)) =
23 FA 77 1B 48 2E 39 20
FF 18 23 F8 6B 98 BC C2
0C FA 0F CC 15 7E 69 78
D7 Al 8B CC A4 C3 B2 81 (the new authentication key).

At step 134, the software 62 generates an authentication response using an authentication response generation algorithm based on the new authentication key 64.

AUTHENTICATION RESPONSE> = ENCODE(

AUTHENTICATION MESSAGE LENGTH> − 2, HASH(

<MODE SECRET> (

<MODE COUNTER> &
<MODE TYPE> &
<MODE INSTANCE>

)

)

) & <MODE COUNTER> MOD 100

Where <AUTHENTICATION MESSAGE LENGTH> is the length of the authentication response.
For example:

<MODE COUNTER> & <MODE TYPE> & <MODE INSTANCE> =
00 00 01 10 00
<MODE SECRET> XOR (<MODE COUNTER> & <MODE TYPE> &
<MODE INSTANCE>) =
23 FA 76 0B 48 2E 39 20
FF 18 23 F8 6B 98 BC C2
0C FA 0F CC 15 7E 69 78
D7 A1 8B CC A4 C3 B2 81
HASH(<MODE SECRET> XOR (<MODE COUNTER> & <MODE
TYPE> & <MODE INSTANCE>)) =
AA 04 89 DD 6D D9 2C 0C
6D FF BE 8D 90 FC 3A CA
FD 49 CE 6D 4F E7 F0 C1
13 68 05 89 0A E8 88 F7
ENCODE(<LENGTH> − 2, HASH(<MODE SECRET> XOR (<MODE
COUNTER> & <MODE TYPE> & <MODE INSTANCE>)))
D1 = 2C MOD 10d = 44 MOD 10 = 4
D2 = 0C MOD 10d = 12 MOD 10 = 2
D3 = 6D MOD 10d = 109 MOD 10 = 9
D4 = FF MOD 10d = 255 MOD 10 = 5
ENCODE(<LENGTH> − 2, HASH(<MODE SECRET> XOR (<MODE
COUNTER> & <MODE TYPE> & <MODE INSTANCE>))) & <MODE
COUNTER> MOD 100 =
429501

The authentication system 30 communicates the authentication response (“429501”) to the user 101 at step 136, for example via the same communication means used to communicate the authentication request.

At step 138, the user 101 receives the authentication response and enters the authentication response (“429501”) into the keypad 70 of the user device 27. At step 140, the software 80 at the user device 27 generates, using the same authentication response generation algorithm, an expected authentication response based on the same authentication key (MODE SECRET). This is done by firstly making a copy of the counter and secret:

<TMP MODE COUNTER> = <MODE COUNTER>
<TMP MODE SECRET> = <MODE SECRET>

The software 80 then increments the temporary counter (TMP MODE COUNTER) and temporary secret (TMP MODE SECRET) until the (TMP MODE COUNTER MOD 10) equals to the last 2 digits of the received authentication response using the following algorithm:

while (<TMP MODE COUNTER> MOD 10 != <AUTHENTICATION
RESPONSE>.RIGHT(2))

<TMP MODE COUNTER> = <TMP MODE COUNTER>
BCDADD 1
<TMP MODE SECRET> = HASH(

<TMP MODE SECRET> XOR (

<TMP MODE COUNTER> &
<MODE TYPE> &
<MODE INSTANCE>
)

)

The software 80 calculates the expected authentication response as follows:

<EXPECTED AUTHENTICATION RESPONSE> =

ENCODE(

<AUTHENTICATION RESPONSE LENGTH> − 2,
HASH(

<TMP MODE SECRET> XOR (
<TMP MODE COUNTER> & <MODE TYPE> &
<MODE INSTANCE>
)

)

) & <TMP MODE COUNTER> MOD 100

The software 80 compares the expected authentication response to the received authentication response, if the authentication response correlates with the received authentication response, indicates that the authentication system 30 is authenticated. In response, the software 80 prompts the user 101 to enter a value to be encrypted at step 142 (equivalent to step 103). The <MODE SECRET> and <MODE COUNTER> are also updated if a matching authentication response is found:

<MODE COUNTER> = <TMP MODE COUNTER>
<MODE SECRET> = <TMP MODE SECRET>

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by the skilled person.

The present application may be used as a basis for priority in respect of one or more future applications, and the claims of any such future application may be directed to any one feature or combination of features that are described in the present application. Any such future application may include one or more of the following claims, which are given by way of example and are non-limiting with regard to what may be claimed in any future application.

1. A method of encrypting a value input into a user device storing an authentication key, a code generation algorithm, and a value verification code generation algorithm, the method including:
the user device processing the authentication key using the code generation algorithm to generate an authentication code;
the user device processing the value using the value verification code generation algorithm to generate a value verification code; and
the user device using the authentication code, the value and the value verification code to construct a message encrypting the value, the message for communicating to an authentication system via a communications network for processing by the authentication system to determine and verify the value, and authenticate the user device and/or the user.

2. A method according to claim 1, wherein processing the value using the value verification code generation algorithm to generate the value verification code further includes processing either the authentication key or a different secret key.

3. A method according to claim 1, wherein using the authentication code, the value and the value verification code to construct a message encrypting the value includes performing a logic or arithmetic operation including at least the authentication code and the value.

4. A method according to claim 3, wherein performing the logic or arithmetic operation includes concatenating the value and value verification code to provide a concatenated sequence, and adding the authentication code using modulus arithmetic to the concatenated sequence.

5. A method according to claim 4, wherein the authentication code, the value and the value verification code comprise a sequence of digits from a digit set comprising X digits, and wherein the modulus arithmetic includes modulus X arithmetic.

6. A method according to claim 4, wherein the authentication code is an n-digit sequence, wherein the value has a sequence length less than the sequence length of the authentication code, and wherein the value verification code has a sequence length which corresponds to the difference between the sequence length of the authentication code and the sequence length of the value.

7. A method according to claim 6, wherein each digit in the authentication code is added separately to a respective digit of the concatenated sequence.

8. A method according to claim 1, wherein processing the authentication key using the code generation algorithm to generate an authentication code further includes processing a PIN entered by a user of the user device.

9. A method according to claim 1, wherein processing the value using the value verification code generation algorithm to generate a value verification code further includes processing a PIN entered by a user of the user device.

10. A method according to claim 1, wherein the value is a replacement PIN for storage at the authentication system.

11. A method of verifying a value communicated to an authentication system via a communications network, the authentication system storing an authentication key associated with a user device, a code generation algorithm, and a value verification code generation algorithm, the method including:
the authentication system receiving a message constructed by a user device;
the authentication system processing the authentication key using the code generation algorithm to generate an expected authentication code;
the authentication system processing the message using the expected authentication code to determine a received value and a received value verification code;
the authentication system processing the received value using the value verification code generation algorithm to generate an expected value verification code;
the authentication system comparing the expected value verification code with the received value verification code; and
in the event that the expected value verification code correlates with the received value verification code, verifying the received value and authenticating the user device and/or the user.

12. A method according to claim 11, wherein processing the received value using the value verification code generation algorithm to generate the expected value verification code further includes processing either the authentication key or a different secret key.

13. A method according to claim 11, wherein processing the message includes performing a logic or arithmetic operation using the expected authentication code.

14. A method according to claim 13, wherein performing the logic or arithmetic operation includes subtracting the expected authentication code from at least part of the message using modulus arithmetic.

15. A method according to claim 14, wherein the expected authentication code and the message are comprised of digits selected from a set of X digits, and wherein the modulus arithmetic uses modulus X arithmetic.

16. A method according to claim 15, wherein each digit of the expected authentication code is subtracted separately from a respective digit of the message.

17. A method according to claim 11, wherein processing the authentication key using the code generation algorithm to generate an expected authentication code further includes processing a PIN associated with the user device and stored at the authentication system.

18. A method according to claim 11, wherein processing the received value using the value verification code generation algorithm to generate an expected value verification code further includes processing a PIN associated with the user device and stored at the authentication system.

19. (canceled)

20. A method of communicating a value input into a user device to an authentication system via a communications network, the user device storing a first authentication key, a first code generation algorithm, and a first value verification code generation algorithm, and the authentication system storing a second authentication key, a second code generation algorithm, and a second value verification code generation algorithm, the method including:
the user device processing the first authentication key using the first code generation algorithm to generate an authentication code;
the user device processing the value using the first value verification code generation algorithm to generate a value verification code;
the user device using the authentication code, the value and the value verification code to construct a message encrypting the value;
communicating the message to the authentication system;
the authentication system receiving the message;
the authentication system processing the second authentication key using the second code generation algorithm to generate an expected authentication code;
the authentication system processing the message using the expected authentication code to determine a received value and a received value verification code;
the authentication system processing the received value using the second value verification code generation algorithm to generate an expected value verification code;
the authentication system comparing the expected value verification code with the received value verification code; and
in the event that the expected value verification code correlates with the received value verification code, verifying the received value and authenticating the user device and/or the user.

21. A user device including:
an input for receiving a value;
an output for outputting a message;
a processor;
a memory storing an authentication key, a code generation algorithm, and a value verification code generation algorithm; and
software resident in memory accessible to the processor, the software including a series of instructions executable by the processor to carry out a method of encrypting a value input into the user device including:
processing the authentication key using the code generation algorithm to generate an authentication code;
processing the value using the value verification code generation algorithm to generate a value verification code;
using the authentication code, the value and the value verification code to construct a message encrypting the value, and
outputting the message, the message for communicating to an authentication system via a communications network for processing by the authentication system to determine and verify the value, and authenticate the user device and/or the user.

22. A user device according to claim 21, wherein the output is an n-digit display, the authentication code is an n-digit sequence, the value has a sequence length less than the sequence length of the authentication code, and the value verification code has a sequence length which corresponds to the difference between the sequence length of the authentication code and the sequence length of the value.

23. A user device according to claim 21, wherein the output is an n-digit display, and wherein the authentication code, the value and the value verification code all have a sequence length of less than n-digits.

24. An authentication system including:
a communications port;
a processor;
a memory storing an authentication key, a code generation algorithm, and a value verification code generation algorithm; and
software resident in memory accessible to the processor, the software including a series of instructions executable by the processor to carry out a method including:
receiving a message;
processing the authentication key using the code generation algorithm to generate an expected authentication code;
processing the message using the expected authentication code to determine a received value and a received value verification code;
processing the received value using the value verification code generation algorithm to generate an expected value verification code;
comparing the expected value verification code with the received value verification code; and
in the event that the expected value verification code correlates with the received value verification code, verifying the received value and authenticating the user device and/or the user.

25. (canceled)

26. (canceled)

27. (canceled)

28. (canceled)
